(19) United States
(12) Patent Application Publication
(10) Pub. No.: US 2017/0111187 A1
(43) Pub. Date: Apr. 20, 2017

(54) ON DEMAND NETWORK SERVICE IN 5TH GENERATION MOBILE NETWORKS

(71) Applicant: NOKIA SOLUTIONS AND NETWORKS OY, Espoo (FI)

(72) Inventors: Paolo ZANIER, Munich (DE); Cinzia SARTORI, Munich (DE); Rainer STADEMANN, Berg (DE); Hanspeter RUCKSTUHL, Wolfratshausen (DE)

(21) Appl. No.: 15/129,125

(22) PCT Filed: Mar. 27, 2014
(86) PCT No.: PCT/EP2014/056169

§ 371 Date: Sep. 26, 2016

(51) Int. Cl. H04L 12/46; H04W 36/32; H04W 4/04

(52) U.S. Cl. CPC H04L 12/4641; H04W 4/046; H04W 36/32; H04W 88/02

(57) ABSTRACT

The present invention addresses method, apparatus and computer program product for on demand virtual switching in 5th generation mobile networks. When a condition is detected that one or more user equipments need a network service, a locally switched or routed virtual network between the user equipments is created, on demand, within a radio access network. The network nodes of the radio access network serving the user equipments in the radio access network are selected and changed according to a movement of the user equipments by respectively employing the network nodes following a service policy.

### FIELD OF THE INVENTION

The present invention generally relates to mobile communication networks, and more specifically relates to a method, apparatus and computer program product for achieving the requirement to support on-demand and wherever needed extremely low latency applications of tenants in 5^{th} generation mobile networks, or, more in general, network service instances with tenant specific requirements.

### BACKGROUND

Mobile data transmission and data services are constantly making progress, wherein such services provide various communication services, such as voice, video, packet data, messaging, broadcast, etc. In recent years, Long Term Evolution LTE™ has been specified, which uses the Evolved Universal Terrestrial Radio Access Network E-UTRAN as radio communication architecture according to 3GPP specification.

However, in such current mobile networks, while few applications still come from the operator core, the vast majority of services come from the Internet, i.e. over the top from an operator point of view. In such a setup, the service edge is at the core network gateway, which is the end point for the end-to-end e2e service tunnel (bearer). Switching (Layer L2) or routing (Layer L3) the user plane traffic more locally near to the radio access is not necessary.

5^{th} generation mobile networks should enable support for extremely low latency applications, which require not only low latency connectivity but also bringing the service itself much closer to radio interface.

An example of such application is vehicular networking for collision avoidance. In principle, vehicle to vehicle communication could happen according to the current paradigm by interconnecting the two communication links at Internet Protocol IP layer behind the mobile network gateway, for instance in a router belonging to an Internet Service Provider ISP.

Solutions for local breakout to the internet, such as Local IP Access LIPA and Selected IP Traffic Offload SIPTO, which are defined e.g. in 3GPP TR 23.829, are currently available and can in theory help to solve the problem as long as the members of the network service instance are rather geo-static and the service needs not to permanently adapt to changes of virtual private network VPN user locations, e.g. when service users move through the network from base station BS to base station. According to so-called “SIPTO above RAN (release 10)”, it is assumed that a Home eNodeB HeNB and local Gateway L-GW are both part of the operator domain. Further, LIPA is only used to access local home/enterprise network. Other services are provided only via operator core, and SIPTO is only used for internet access.

Similar functionality as the one necessary to create flexible virtual tenant networking is today utilized in data centers. In data centers the virtual networking for the virtual machines VM of tenants needs to adapt, when VMs are migrated from one location to another location in the data centers. It is referred to e.g. “VL2: A Scalable and Flexible Data Center Network”, A. Greenberg et al., SigComm 2009, for a summary of an example on state of the art in data centers. In order to understand the relation between this example and mobile networks, it may be assumed that the virtual machines VM are end user devices, e.g. user equipment UE, and the central addressing service is communicating with a mobile control plane, which is aware of the location of the UEs. In the context of this invention a UE can be a human end user communication device, e.g. smartphone, or a machine device, e.g. a communication device inbuilt into a car. Also it is possible that the UE itself is a gateway node to another private network, e.g. the onboard network of a car.

Finally, proprietary solutions for IP interconnect within the base station are envisioned by some vendors but cannot guarantee interoperability in a multi-vendor environment and are still static thus not suitable for ‘moving’ VPNs or VPNs with dynamic topology.

### SUMMARY OF THE INVENTION

Therefore, in order to overcome the drawbacks of the prior art, the present invention provides a solution for supporting low latency applications in 5^{th} generation mobile networks or more in general, network service instances with tenant specific requirements.

In particular, the present invention provides a method, apparatus and computer program product for enabling on demand network service instances in 5^{th} generation mobile networks. Additionally it is enabled that the networking service instance is automatically reconfigured according to movements of its service users, following a pre-defined service optimization policy.

According to a first aspect of the present invention, there is provided a method, comprising detecting a condition that one or more UEs require a network service (e.g. due to a disability of establishing a direct ad-hoc connection between two UEs), and creating or modifying, when requirement is detected, a locally switched or routed network service instance between corresponding UEs within a radio access network, wherein the network nodes of the radio access network serving the corresponding UEs in the radio access network are selected and changed according to a movement of the UEs by respectively employing the network nodes following a predefined service policy.

According to a second aspect of the present invention, there is provided an apparatus, comprising a detection device, configured to detect a condition that one or more user equipments require a network service instance (e.g. configure to detect the disability of establishing an ad-hoc connection between two UEs), a processing device, a processing device, configured to create, when requirement is detected, a locally switched or routed network service instance between corresponding user equipments within a radio access network, and a selection device configured to select and change network nodes of the radio access network serving the corresponding user equipments in the radio access network according to a movement of the corresponding user equipments by respectively employing the network nodes following a service policy.

According to a third aspect of the present invention, there is provided a computer program product comprising computer-executable components which, when the program is run, are configured to carry out the method according to the first aspect.

Advantageous further developments or modifications of the aforementioned exemplary aspects of the present invention are set out in the dependent claims.

According to certain embodiments of the present invention, the radio access network is a network according to 5^{th} generation mobile network architecture.

Further, according to certain embodiments, the network service instance is a switched or routed network service instance.

Further, according to certain embodiments of the present invention, one or more of the UEs are part of respective locally switched or routed ad-hoc networks, wherein, according to certain embodiments, the respective locally switched or routed ad-hoc networks are vehicle-to-vehicle communications networks, using e.g. wireless access in vehicular environments (WAVE, IEEE 1609, IEEE 802.11p) standards.

Further, according to certain embodiments of the present invention, the service policy is the policy to select the nearest possible network node with regard to the location of the respective corresponding user equipment for minimizing communication latency.

Further, according to certain embodiments of the present invention, the control functionality for at least one of setup, modification and removal of a network service instance is provided by a control node which communicates directly or indirectly with the mobility management function of the mobile network control plane.

Further, according to certain embodiments of the present invention, the locally switched or routed service instance is a low latency virtual private network.

According to certain embodiments of the present invention, the network service instance is a virtual network with dynamic topology, and service instance forwarding functions of the virtual network are implemented in the network nodes.

According to certain embodiments of the present invention, a user equipment of the corresponding user equipments which moves with high speed through the radio access network is anchored to a service instance forwarding function in a more centralized aggregation node, whereas a more geo-static user of the corresponding user equipments is anchored to a service instance forwarding function in a more local network node.

According to certain embodiments of the present invention, the network service instance is a software defined virtual network applying OpenFlow switches placed in base stations sites and aggregation nodes and being connected to a software defined networking controller, the software defined networking controller is configured to reconfigure the topology of the software defined virtual network on demand using a control protocol, such as e.g. the OpenFlow control plane. Thereby, the northbound interface of the software defined networking controller is connected directly or indirectly to the mobility management function of the 5G control plane, and the mobility management function informs the software defined networking controller about mobility events (e.g. handovers, network attachments and detachments) to re-configure the virtual network topology while a plurality of user equipments moves through the network.

Still further, according to certain embodiments, the respective locally switched ad-hoc networks are vehicle-to-vehicle networks, and the radio access network acts as backup.

### BRIEF DESCRIPTION OF DRAWINGS

For a more complete understanding of example embodiments of the present invention, reference is now made to the following descriptions taken in connection with the accompanying drawings in which:

FIG. 1 schematically shows a device to device (e.g. a UE to UE) communication via Core Network mobile gateway according to the prior art;

FIG. 2 illustrates a round trip time RTT of a ping from a UE to a mobile gateway in an LTE network according to the prior art;

FIG. 3 shows an example embodiment of a vehicular networking use case to which the invention can be advantageously be applied;

FIG. 4 shows the user and transport plane for the distributed Ethernet service instance connecting the vehicles depicted in FIG. 3 according to certain embodiments of the present invention;

FIG. 4a shows further details of the scheme in FIG. 4 according to certain embodiments of the invention by showing that the service flow tunnels between base station BS and the service instance forwarding function in the vSwitch are the result of the association of virtual ingress/egress ports of the service instance forwarding function to uplink/downlink UL/DL service flow tunnel endpoints;

FIG. 5 shows the control plane elements in addition to the user and transport plane elements in a certain embodiment for the use case depicted in FIG. 4;

FIG. 6 shows the service flow tunnel configuration after the handover was completed, according to certain embodiments;

FIG. 7 shows a messaging between a mobility management entity MME and a software defined networking controller SDNC (interface Sc) according to certain embodiments of the invention, which is used to optimize the ETH service instance, that is to move the SAPI for UE2 from vSwitch B to vSwitch A;

FIG. 8 illustrates a method according to certain embodiments of the invention;

FIG. 9 schematically illustrates an apparatus according to certain embodiments of the invention; and

FIG. 10 schematically shows a support for low-latency vehicle to vehicle communication according to certain embodiments of the present invention.

### DESCRIPTION OF EXEMPLARY EMBODIMENTS

Exemplary aspects of the present invention will be described herein below. More specifically, exemplary aspects of the present invention are described hereinafter with reference to particular non-limiting examples and to what are presently considered to be conceivable embodiments of the present invention. A person skilled in the art will appreciate that the invention is by no means limited to these examples, and may be more broadly applied.

It is to be noted that the following description of the present invention and its embodiments mainly refers to specifications being used as non-limiting examples for certain exemplary network configurations and deployments. Namely, even if the present invention relates to 5^{th} generation mobile networks, its embodiments are also described in relation to 3GPP terminology being used as non-limiting examples for certain exemplary network configurations and deployments. Such terminology is only used in the context of the presented non-limiting examples, and does naturally not limit the invention in any way. Rather, any other network configuration or system deployment, etc. may also be utilized as long as compliant with the features described herein.

Hereinafter, various embodiments and implementations of the present invention and its aspects or embodiments are described using several alternatives. It is generally noted that, according to certain needs and constraints, all of the described alternatives may be provided alone or in any conceivable combination, also including combinations of individual features of the various alternatives.

In particular, the following example versions and embodiments are to be understood only as illustrative examples. Although the specification may refer to “an”, “one”, or “some” example version(s) or embodiment(s) in several locations, this does not necessarily mean that each such reference is to the same example version(s) or embodiment(s), or that the feature only applies to a single example version or embodiment. Single features of different embodiments may also be combined to provide other embodiments. Furthermore, words “comprising” and “including” should be understood as not limiting the described embodiments to consist of only those features that have been mentioned and such example versions and embodiments may also contain features, structures, units, modules etc. that have not been specifically mentioned.

In general, a telecommunication network comprises plural network elements, such as base stations BS, evolved NodeB's (eNB; i.e. base station in LTE environment), user equipments UE (e.g. mobile phone, smart phone, Computer, communication device in a car, etc.), controllers, interfaces, etc, and in particular any equipment used in the provision of a telecommunications service.

The general functions and interconnections of the described elements, which also depend on the actual network type, are known to those skilled in the art and described in corresponding specifications, so that a detailed description thereof is omitted herein. However, it is to be noted that several additional network elements and signaling links may be employed for a communication to or from a base station and a communication network besides those described in detail herein below.

As already indicated above, the present invention provides a solution for performing low latency applications in 5^{th} generation mobile networks. An example of such application is vehicular networking for collision avoidance. However, it is to be noted that the present invention is not restricted to vehicular networking application, but may also be employed in several other applications which are apparent for a skilled person in the field (e.g. cooperative robotics applications).

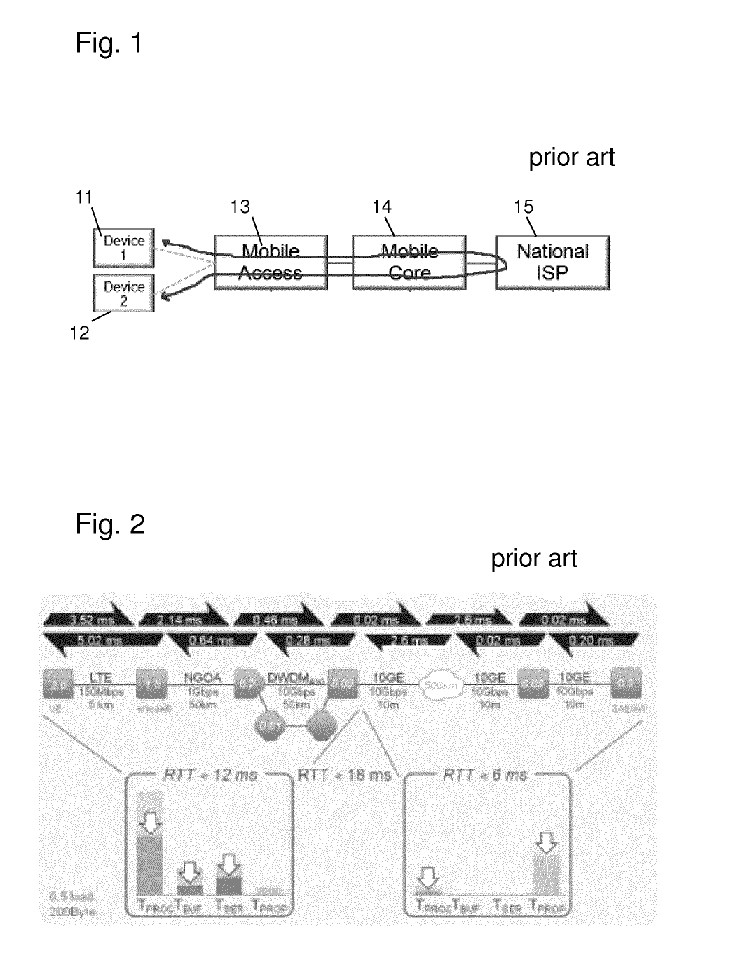

In principle, according to certain known mobile network solutions, a vehicle to vehicle communication may be established by interconnecting two communication links at Internet Protocol IP layer behind the mobile network gateway, as shown in FIG. 1.

In particular, as is depicted in FIG. 1 a communication link at IP layer from a Device 1 11 to a Device 2 12 is established via a mobile access entity 13, a mobile core 14 and a national internet service provider ISP 15 and way back via the mobile core 14 and the mobile access entity 13, which is depicted by an arrow. Such link causes certain latency.

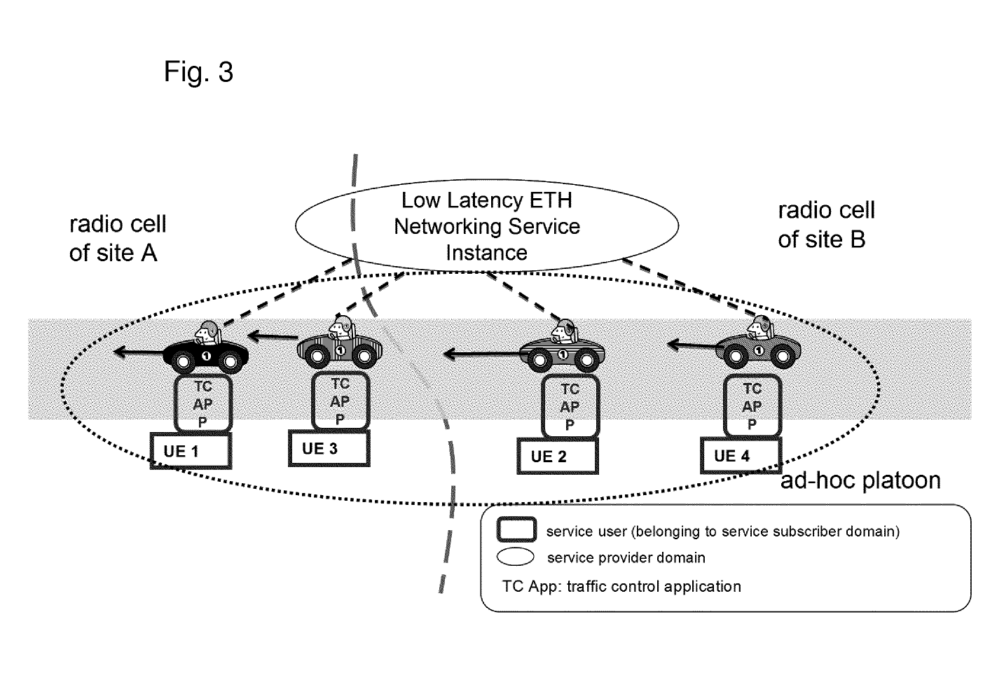

To get an idea of the implications in terms of latency, FIG. 2 shows as an example round trip delay of a 200 Bytes packet (ping) from a user equipment UE 21 to the mobile gateway (SAE GW) 22 and back according to LTE network architecture. Note also, that for not exceeding the round trip time RTT the complete end-to-end chain must be engineered not to become overloaded at any time. This leads either to high OPEX (operational expenditure) for the engineering task or high CAPEX (capital expenditure) when resources are over-engineered. Considering the delay introduced by this communication paradigm and the uncertainty that latency limits are met, it may only be used for non-critical applications.

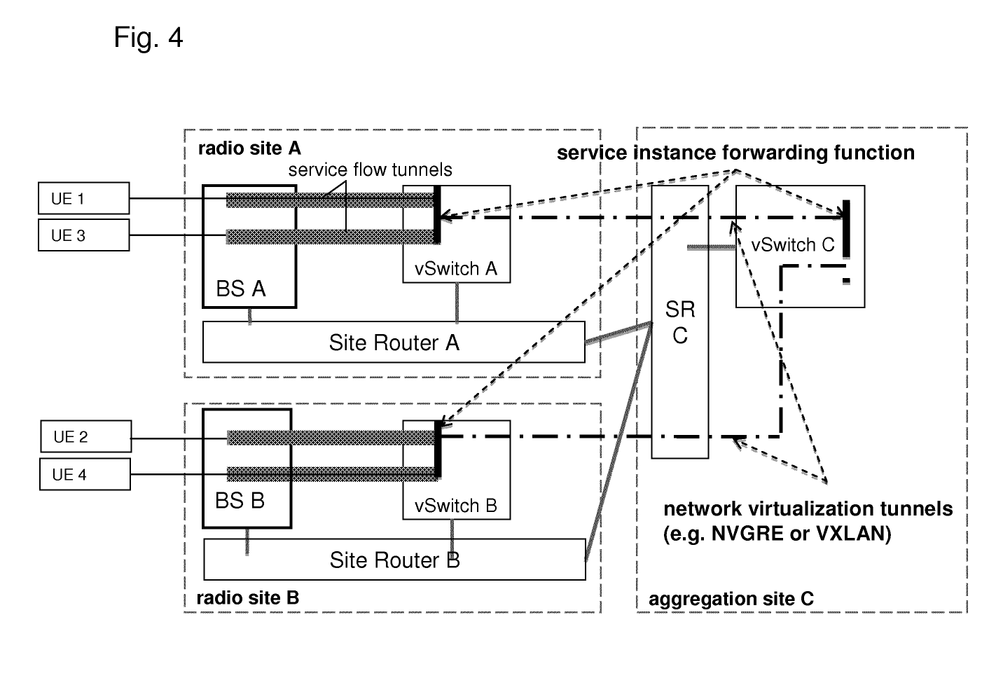

FIG. 3 shows a vehicular networking use case, to which the invention advantageously can be applied. It shows four vehicles driving as an ad-hoc platoon on the highway. For mutual traffic information exchange, control or alarming purposes, a virtual networking service instance has been created on-demand for this platoon. In the situation shown, the service instance extends across to radio sites A and B, with UE 1 and UE 3 being connected via radio site A to the service instance, and UE2 and UE4 being connected via radio Site B to the same service instance.

According to certain embodiments, the invention can be advantageously applied to this scenario by providing 5^{th} generation networks with the capability to create, on demand network service instances at or close to the radio and aggregation sites in the Radio Access Network and to permanently adapt the service instance topology to the moving UE to guarantee lowest latency.

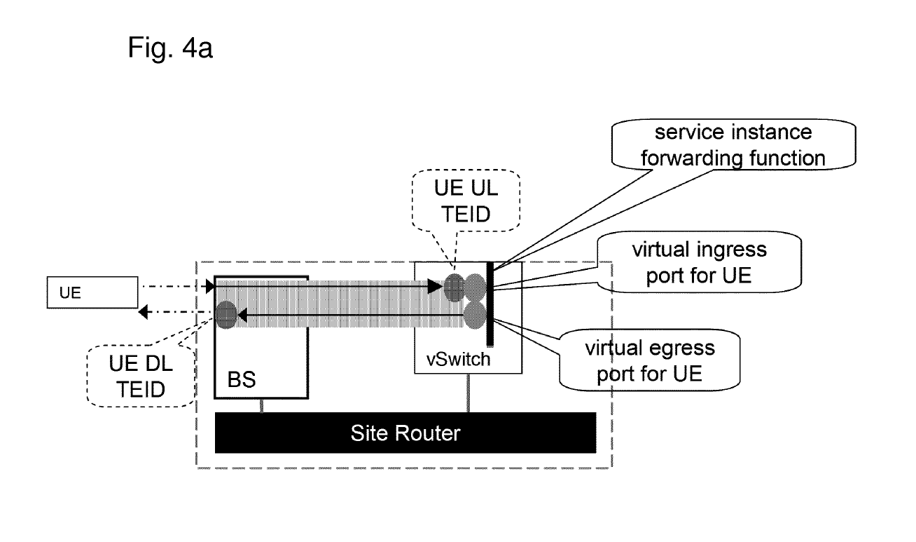

An embodiment of the invention for the user and transport plane is shown in FIG. 4. It is related to the example of FIG. 3. It shows the two radio sites A and B as well as the aggregation site C to which both radio sites are interconnected.

The interconnection is built by a transport network consisting of the site routers SR A, B and C. In each of the radio sites A and B, a base station BS is interconnected via the local site router to a virtual switch entity ‘vSwitch’. In the aggregation site C there is a vSwitch C connected to the local site router SR C. An example for a vSwitch implementation is given by the public “Open Virtual Switch” project ‘openvswitch.org’.

FIG. 4 also shows service instance forwarding functions, indicated as vertical bars within the vSwitches. The service instance forwarding functions are logically interconnected between sites A, B and C using network virtualization tunnels. Examples for network virtualization tunnels are NVGRE (see http://tools.ietf.org/html/draft-sridharan-virtualization-nvgre-04) or VXLAN (see http://tools.ietf.org/html/draft-mahalingam-dutt-dcops-vxlan-08).

In addition, FIG. 4 shows four service flow tunnels which transport the service frames between the serving BS of the UE and the respective service access point of the network service instance in vSwitch A or B, respectively. Service flow tunnels can make use of e.g. GTP tunnel (3GPP TS 29.060) or GRE tunnel (RFC 2784, RFC 2890) technology.

FIG. 4a shows that, in this embodiment, a service flow of an UE may consist of an uplink UL tunnel from the serving BS to the ingress port of the network service instance forwarding function in the vSwitch, and a downlink DL tunnel from the egress port of the network service instance forwarding function to the serving BS. Ingress and egress ports are associated to the same service access point. The UL/DL tunnels are identified by corresponding UL/DL tunnel endpoints.

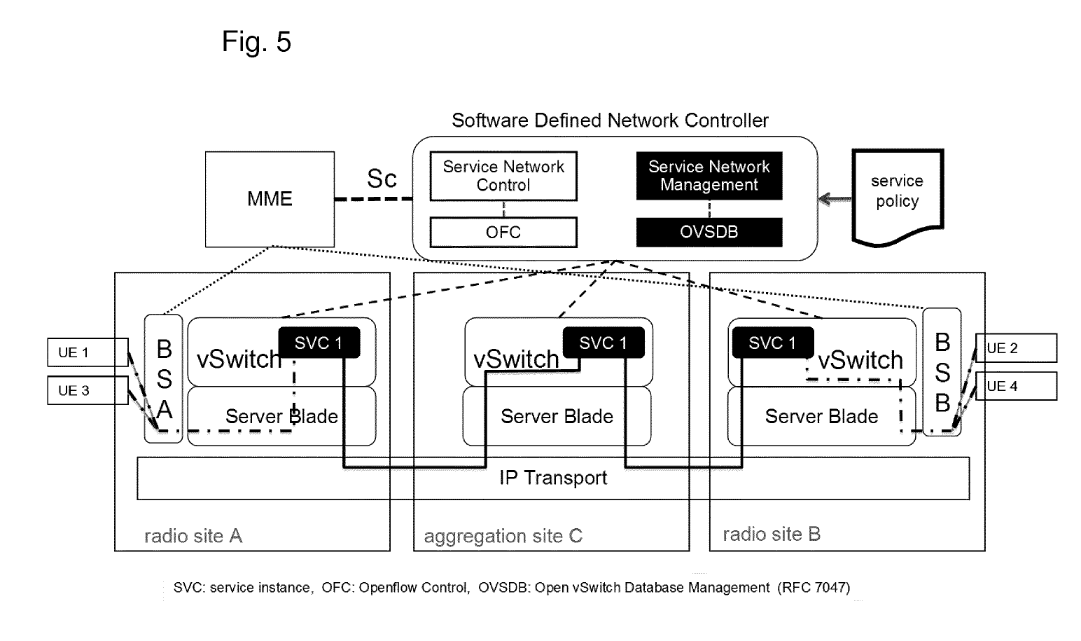

FIG. 5 shows in addition to the schematic user and transport plane configuration of FIG. 4 a mobility management entity MME of the mobile network which communicates via an interface Sc with a software defined networking controller SDNC. The SDNC entity controls and manages the vSwitch appliances running on general purpose server blades in the radio network sites A, B and C. For this control purpose, the SDNC makes in this embodiment use of the Openflow Control protocol (opennetworking.org) and the Open vSwitch Database Management Protocol (RFC 7047).

The SDNC is able to reconfigure the network service instance topology on demand using the above mentioned control and management protocols for the vSwitch appliances. Via the interface Sc the MME informs the SDNC about mobility events (e.g. handovers, network attachments and detachments) enabling the software defined networking controller SDNC to instantiate, re-configure and destroy the network service instance when UEs move through the network.

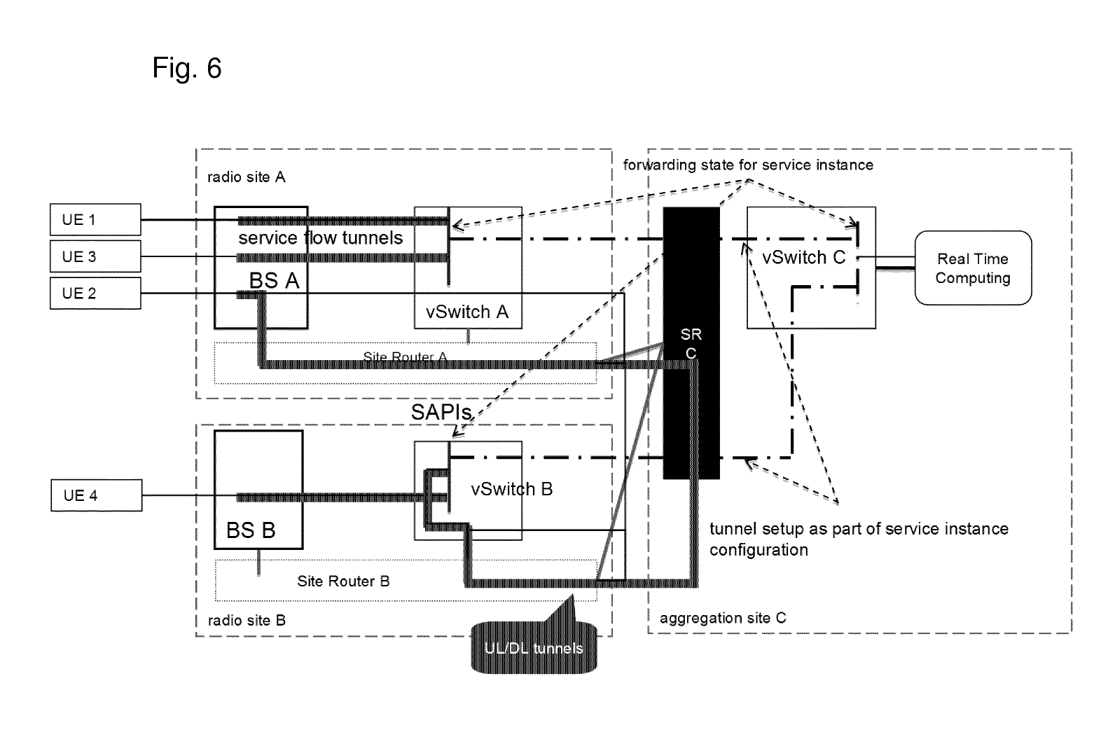

FIG. 6 shows that the network service instance topology after the completion of the handover of UE2 between BS B and BS A is not optimal. In fact, even though UE2 is now connected to BS A, which allocated a new DL tunnel endpoint for UE2, its associated access point to the network service instance is still located in vSwitch B.

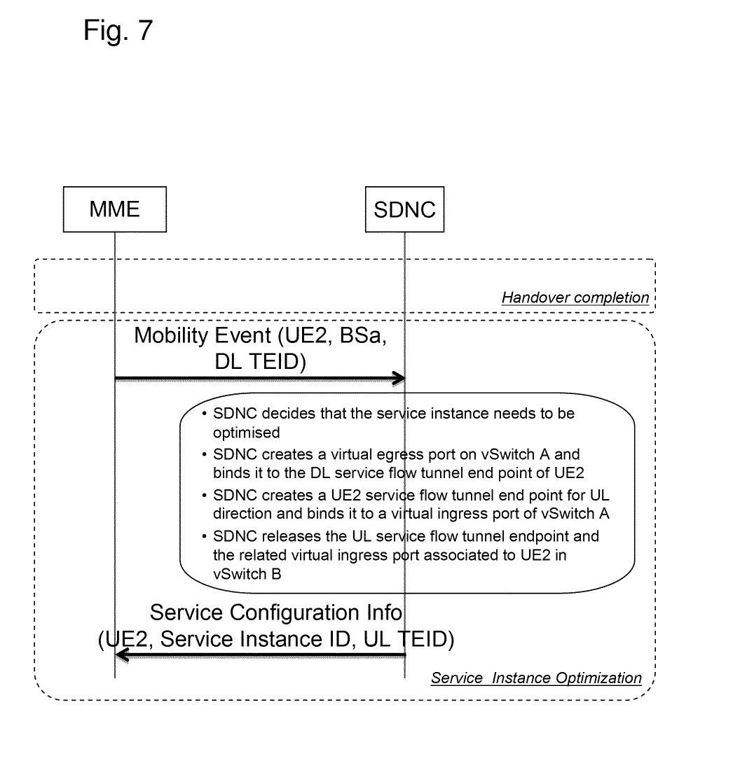

A reconfiguration of the network service instance is triggered by the SDNC when the MME informs it about UE2 mobility event, as shown in FIG. 7.

First, the SDNC creates a virtual egress port on the network service instance forwarding function in vSwitch A and binds it to the DL service flow tunnel end point of UE2 in BS A. Then, it creates a UE2 service flow tunnel end point for UL direction and binds it to a virtual ingress port of the service instance forwarding function in vSwitch A. In addition, the SDNC releases the UL service flow tunnel endpoint and the related virtual ingress port associated to UE2 in vSwitch B. Finally the SDNC informs the MME about the new UL tunnel end point on vSwitch A with the “service configuration info” message.

The final network service instance topology is similar to the one depicted in FIG. 4, however with UE2 connected like UE1 and UE3 to the service instance forwarding function in vSwitch A.

Additionally to latency boundaries, control plane performance aspects can be taken into account, e.g. a user equipment UE moving with high speed through the network may be anchored to a switching function in a more centralized aggregation node, while slower moving UE are anchored to a switching function of its respective base station BS.

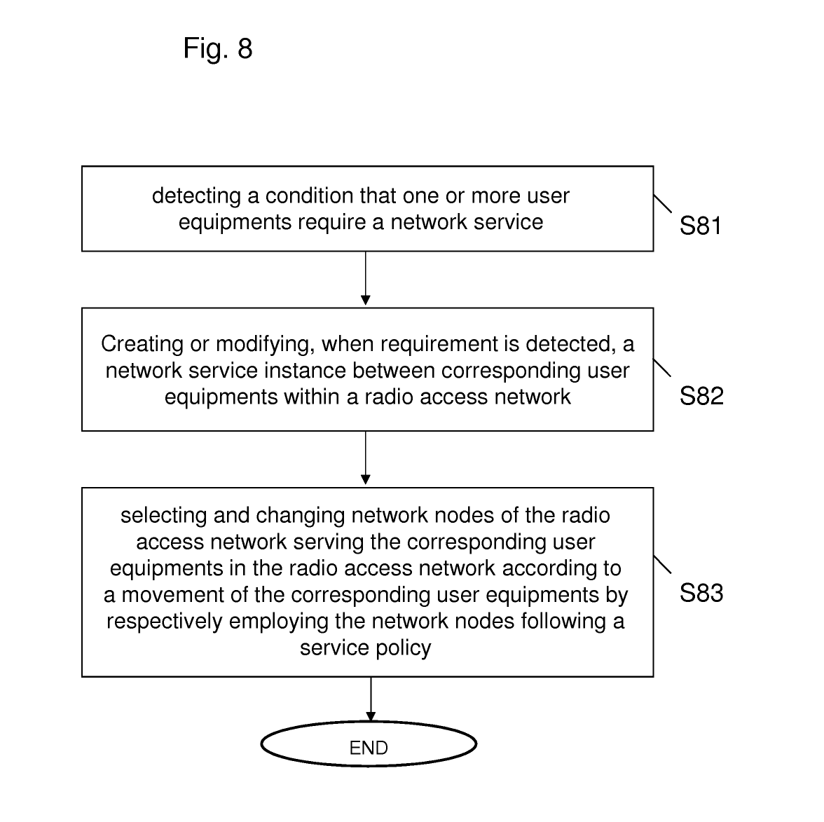

FIG. 8 shows a method according to some example versions of the disclosure.

In Step S81, a condition that one or more user equipments require a network service is detected.

Further, in Step S82, when requirement is detected, a network service instance between corresponding user equipments within a radio access network is created or modified.

Still further, in Step S83, the network nodes of the radio access network serving the corresponding user equipments in the radio access network are selected and changed according to a movement of the corresponding user equipments by respectively employing the network nodes following a service policy.

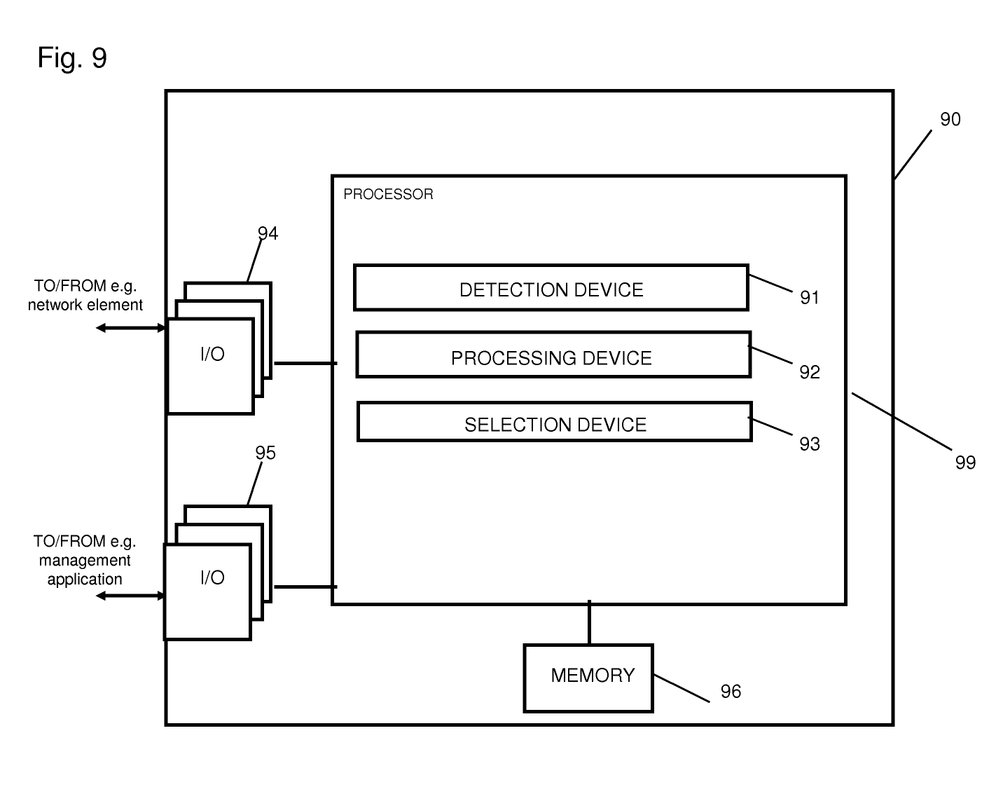

In FIG. 9, a diagram illustrating a configuration of an apparatus 90 is described in connection with some of the example versions of the present disclosure. The embodiment may be carried out in or by a (virtual) network entity. It is to be noted that the network entity may comprise elements or functions, such as a chipset, a chip, a module etc., which can also be part of a network entity or attached as a separate element to a network entity, or the like. It should be understood that each block and any combination thereof may be implemented by various means or their combinations, such as hardware, software, firmware, one or more processors and/or circuitry.

The apparatus 90 shown in FIG. 9 may comprise a processing function, control unit or processor, such as a CPU or the like, which is suitable for executing instructions given by programs or the like related to the network entity control procedure, and which is suitable for controlling the apparatus or an application serving as the apparatus.

The processor 99 is configured to execute processing related to the above described processing of on demand virtual switching or routing in 5^{th} generation mobile networks. In particular, the processor 99 comprises a sub-portion 91 as a detection device configured to detect a condition that one or more user equipments require a network service. The portion 91 may be configured to perform processing according to S81 of FIG. 8. Furthermore, the processor comprises a sub-portion 92 usable as a processing device configured to create or modify, when requirement is detected, a (e.g. locally switched or routed) network service instance between corresponding user equipments within a radio access network. The portion 92 may be configured to perform processing according to S82 of FIG. 8. Furthermore, the processor comprises a sub-portion 93 usable as a selection device configured to select and change network nodes of the radio access network serving the corresponding user equipments in the radio access network according to a movement of the corresponding user equipments by respectively employing the network nodes following a service policy. The portion 93 may be configured to perform a processing according to S83 of FIG. 8.

Reference signs 94 and 95 denote transceiver or input/output (I/O) units (interfaces) connected to the processor. The I/O units 94, 95 may be used for communicating. Even if not explicitly depicted in FIG. 9, a memory 96 may be applied, which is usable, for example, for storing data and programs to be executed by the processor 99 and/or as a working storage of the processor 99.

According to certain exemplary embodiments of the present invention, a possible implementation of the invention relies on applying Software Defined Network principles to 5^{th} generation mobile networking.

In this case, virtual OpenFlow (OF) switches (vSwitches) are placed in base stations and aggregation nodes. vSwitches are connected to an SDN controller which is able to reconfigure the virtual network topology on demand using the OF-control plane. The northbound interface of the SDN controller is connected directly or indirectly to the mobility management function MMF of the 5G control plane. Via this interface the MMF informs the SDN controller directly or indirectly about mobility events (e.g. handovers, network attachments and detachments) enabling the software defined networking controller to re-configure the virtual network topology when UE move through the network.

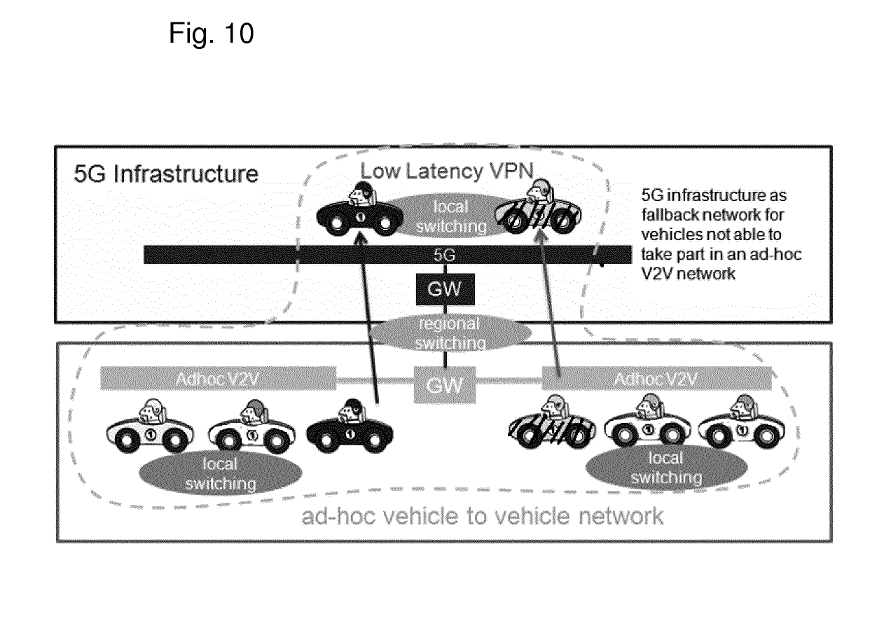

FIG. 10 shows, as a non-limiting example, the use case of support for low-latency vehicle to vehicle communication according to certain embodiments of the present invention.

According to certain embodiments, the 5^{th} generation network infrastructure can be used as a backup for vehicular ad-hoc communication. Fulfilling the latency requirements would not be possible with setups where each connection between devices goes first to the service edge and comes back to the radio, as shown in FIG. 1.

Instead, by implementing the present invention and thereby having the capability to instantiate a local switch when the black and hatched cars in FIG. 10 get connected to 5th generation mobile infrastructure achieves the following benefits:

a) Creation of “virtual networks”, e.g. all cars/subset of cars e.g. for black and hatched ones in FIG. 10. By creation of virtual service networks, messages can be exclusively exchanged/sent to cars group(s)/subgroup(s), while other users/machines connected to the same mobile network are not involved (multicast).
b) The cars still belong to the local layer 2 network, thus there is no impact on the IP layer.
c) Instantiating the local switch in the closest network node allows minimizing the communication latency.
d) Having the capability to move the switch with the cars along their path allows keeping the communication latency low.

It is to be noted that embodiments of the present invention may be implemented as circuitry, in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer or smart phone, or user equipment.

The present invention relates in particular but without limitation to mobile communications, for example to environments under 5^{th} generation mobile network, and can advantageously be implemented also in controllers, base stations, user equipments or smart phones, or self optimizing networks computers connectable to such networks. That is, it can be implemented e.g. as/in chipsets to connected devices.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

Furthermore, the described network elements, such as terminal devices or user devices like UEs, communication network control elements of a cell, like a BS or an eNB, access network elements like APs and the like, as well as corresponding functions as described herein may be implemented by software, e.g. by a computer program product for a computer, and/or by hardware. In any case, for executing their respective functions, correspondingly used devices, nodes or network elements may comprise several means, modules, units, components, etc. (not shown) which are required for control, processing and/or communication/signaling functionality. Such means, modules, units and components may comprise, for example, one or more processors or processor units including one or more processing portions for executing instructions and/or programs and/or for processing data, storage or memory units or means for storing instructions, programs and/or data, for serving as a work area of the processor or processing portion and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means, radio interface means comprising e.g. an antenna unit or the like, means for forming a radio communication part etc.) and the like, wherein respective means forming an interface, such as a radio communication part, can be also located on a remote site (e.g. a radio head or a radio station etc.). It is to be noted that in the present specification processing portions should not be only considered to represent physical portions of one or more processors, but may also be considered as a logical division of the referred processing tasks performed by one or more processors.

1.-24. (canceled)

25. A method, comprising:
detecting a condition that one or more user equipments require a network service; and
creating or modifying, when requirement is detected, a network service instance between corresponding user equipments within a radio access network,
wherein network nodes of the radio access network serving the corresponding user equipments in the radio access network are selected and changed according to a movement of the corresponding user equipments by respectively employing the network nodes following a service policy.

26. The method according to claim 25, wherein the network service instance is a switched or routed network service instance.

27. The method according to claim 25, wherein the one or more user equipments are part of respective locally switched or routed ad-hoc networks.

28. The method according to claim 25, wherein the service policy is the policy to select the nearest possible network node with regard to the location of the respective corresponding user equipment for minimizing communication latency.

29. The method according to claim 25, wherein the network service instance is a low latency virtual private network.

30. The method according to claim 25, wherein the network service instance is a virtual network with dynamic topology, and the service instance forwarding functions of the virtual network are implemented in the network nodes.

31. The method according to claim 25, wherein a user equipment of the corresponding user equipments which moves with high speed through the radio access network is anchored to a service instance forwarding function in a more centralized aggregation node, whereas a more geo-static user of the corresponding user equipments is anchored to a service instance forwarding function in a more local network node.

32. The method according to claim 25, wherein the network service instance is a software defined virtual network applying OpenFlow switches placed in base stations sites and aggregation nodes and being connected to a software defined networking controller, the software defined networking controller is configured to reconfigure the topology of the software defined virtual network on demand using a control protocol.

33. The method according to claim 32, wherein a northbound interface of the software defined networking controller is connected directly or indirectly to the mobility management function of the 5G control plane, and the mobility management function informs the software defined networking controller about mobility events to re-configure the virtual network topology while a plurality of user equipments move through the network.

34. The method according to claim 27, wherein the respective locally switched ad-hoc networks are vehicle-to-vehicle networks, and the radio access network acts as backup.

35. An apparatus, comprising:
a detection device, configured to detect a condition that one or more user equipments require a network service;
a processing device, configured to create, when requirement is detected, a locally switched or routed network service instance between corresponding user equipments within a radio access network; and
a selection device configured to select and change network nodes of the radio access network serving the corresponding user equipments in the radio access network according to a movement of the corresponding user equipments by respectively employing the network nodes following a service policy.

36. The apparatus according to claim 35, wherein the network service instance is a switched or routed network service instance.

37. The apparatus according to claim 35, wherein the one or more user equipments are part of respective locally switched or routed ad-hoc networks.

38. The apparatus according to claim 35, wherein the service policy is the policy to select the nearest possible network node with regard to the location of the respective corresponding user equipment for minimizing communication latency.

39. The apparatus according to claim 35, wherein the network service instance is a low latency virtual private network.

40. The apparatus according to claim 35, wherein the network service instance is a virtual network with dynamic topology, and service instance forwarding functions of the virtual network are implemented in the network nodes.

41. The apparatus according to claim 35, wherein a user equipment of the corresponding user equipments which moves with high speed through the radio access network is anchored to a service instance forwarding function in a more centralized aggregation node, whereas a more geo-static user of the corresponding user equipments is anchored to a service instance forwarding function in a more local network node.

42. The apparatus according to claim 35, wherein network service instance is a software defined virtual network applying OpenFlow switches placed in base stations sites and aggregation nodes and being connected to a software defined networking controller, the software defined networking controller is configured to reconfigure the topology of the software defined virtual network on demand using a control protocol.

43. The apparatus according to claim 42, wherein a northbound interface of the software defined networking controller is connected directly or indirectly to the mobility management function of the 5G control plane, and the mobility management function informs the software defined networking controller about mobility events to re-configure the virtual network topology while a plurality user equipments moves through the network.

44. The apparatus according to claim 37, wherein the respective locally switched ad-hoc networks are vehicle-to-vehicle networks, and the radio access network acts as backup.
